(19) United States
(12) Patent Application Publication
(10) Pub. No.: US 2011/0009518 A1
(43) Pub. Date: Jan. 13, 2011

(54) Photosetting type bio-based coating composition and its coated article

(75) Inventors: Naoya Yabuuchi, Osaka (JP); Koji Morita, Osaka (JP); Hirofumi Yamashita, Osaka (JP); Hitomi Ohara, Kyoto (JP); Shiro Kobayashi, Kyoto (JP); Masahiko Ishii, Aichi (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignees: NIPPON BEE CHEMICAL CO., LTD., Osaka (JP); National University Corporation Kyoto Institute of Technology, Kyoto (JP); TOYOTA JIDOSHA KABUSHIKI KAISHA, Aichi (JP)

(21) Appl. No.: 12/787,626

(22) Filed: May 26, 2010

(30) Foreign Application Priority Data
Jul. 8, 2009 (JP) 2009-161778

(51) Int. Cl. C08F 2/46

(52) U.S. Cl. 522/183

(57) ABSTRACT

There are provided a photosetting type bio-based coating composition and its coated article, wherein the coating composition has a sufficient hydrolysis resistance and a sufficient crosslinking density so as to be excellent in such as long-term stability, and is inexpensive, and is applicable also to an aqueous solvent. The photosetting type bio-based coating composition according to the present invention is characterized by comprising: a bio-based photopolymerizable compound as a film-forming ingredient which compound has at least one lactic acid unit and at least one photopolymerizable group together in a molecule; and a photopolymerization initiator. The coated article according to the present invention is characterized by being obtained by being coated with the aforementioned coating composition.

### BACKGROUND OF THE INVENTION

A. Technical Field

The present invention relates to a photosetting type bio-based coating composition and its coated article. In detail, the present invention relates to a photosetting type bio-based coating composition and a coated article as coated therewith, wherein the coating composition is based on lactic acid that is a bio-based ingredient.

B. Background Art

Coated articles as coated with conventional type coating compositions comprising petroleum-based materials are disposed of, for example, by releasing their coating films from base materials and thereafter incinerating the released coating films or scrapping them into soil. However, in cases where incineration disposal is carried out, vain energy becomes necessary for the incineration. In addition, there is a worry that the global warming may proceed due to carbon dioxide generated by the incineration of the coating films. In addition, depending on the coating films, if the incineration is carried out, then a hydrogen chloride gas is generated and causes acid rain. Moreover, in cases where coating films are scrapped into soil, it is difficult to secure sites for the disposal of the waste, and further, there is also a worry that the coating films may reside for a long time, so that the environment or the ecosystem in soil may be destroyed.

In addition, in cases where it is needed to lower the viscosity of a coating composition during such as spray coating or coating in several microns with a roll coater, usually, methods are adopted in which a reactive diluent is used in a large amount or an organic solvent is also used. However, in the case where the reactive diluent is used in a large amount, there easily occur problems of skin irritation or setting-property deterioration. In addition, in the case where the organic solvent is also used, risks of air pollution or fires become high. Thus, a coating composition possible to render aqueous is being demanded from viewpoints of such as air pollution prevention, regulations on fire laws, and labor safety hygiene.

Thus, in order to solve the above problems, there is proposed an aqueous coating composition comprising a major proportion of a polylactic acid which is a bio-based material (e.g. refer to patent document 1 below). By this art, the environmental load is reduced when compared with conventional petroleum-based materials, but there are the following problems: such as water resistance and alkali resistance are insufficient, and the crosslinking density of the resultant coating film is so low that such as hardness and scratch resistance are also low, and therefore the use is extremely limited.

Therefore, there is also proposed a photosetting type bio-based coating composition in which there is used a polylactic acid having a photoreactive substituent introduced from the viewpoint of increasing the crosslinking density (e.g. patent document 2 below). Specifically, a cinnamoyl group is used as the photoreactive substituent, and by its photodimerization, the photocrosslinking is caused. However, since the reaction efficiency of the photodimerization of the cinnamoyl group is low, a sufficient crosslinking density cannot be obtained, so that the coating film properties such as hardness and scratch resistance are not sufficient.

### [Prior Art Documents]:

### [Patent Documents]:

[Patent Document 1]: JP-A-2006-291000

[Patent Document 2]: JP-A-2008-195838

### SUMMARY OF THE INVENTION

### A. OBJECT OF THE INVENTION

Thus, an object of the present invention is to provide a photosetting type bio-based coating composition and its coated article, wherein the coating composition has a sufficient hydrolysis resistance and a sufficient crosslinking density so as to be excellent in such as long-term stability, and is inexpensive, and is applicable also to an aqueous solvent.

### B. DISCLOSURE OF THE INVENTION

The present inventors diligently studied to achieve the above object. As a result, they have completed the present invention by finding out and confirming that if a bio-based photopolymerizable compound which, in a bio-based compound having at least one lactic acid unit, further has at least one photopolymerizable group is used as a film-forming ingredient and jointly with a photopolymerization initiator to thereby constitute a photosetting type bio-based coating composition, then there is obtained a coating composition which is bio-based and extremely low in environmental load, but can form a dense self-crosslinked structure by photopolymerization so as to have a sufficient hydrolysis resistance and a sufficient crosslinking density so as to be excellent in such as long-term stability, and is inexpensive, and is applicable to an aqueous solvent.

That is to say, a photosetting type bio-based coating composition according to the present invention is characterized by comprising:

a bio-based photopolymerizable compound as a film-forming ingredient which compound has at least one lactic acid unit and at least one photopolymerizable group together in a molecule; and

a photopolymerization initiator.

In addition, a coated article according to the present invention is characterized by being obtained by being coated with the aforementioned coating composition.

### C. EFFECTS OF THE INVENTION

The present invention provides a coating composition and a coated article comprising the use of this coating composition, wherein the coating composition is bio-based and extremely low in environmental load, but has a sufficient hydrolysis resistance and a sufficient crosslinking density so as to be excellent in such as long-term stability, and is inexpensive, and is applicable to an aqueous solvent.

### BRIEF DESCRIPTION OF THE DRAWINGS

FIG. 1 is a schematic view showing an example of a branched type structure preferable as the bio-based photopolymerizable compound according to the present invention.

FIG. 2 is a schematic view showing another example of a branched type structure preferable as the bio-based photopolymerizable compound according to the present invention.

### DETAILED DESCRIPTION OF THE INVENTION

Hereinafter, detailed descriptions are given about modes for carrying out the present invention. However, the scope of the present invention is not bound to these descriptions. And other than the following illustrations can also be carried out in the form of appropriate modifications of the following illustrations within the scope not departing from the spirit of the present invention.

[Film-Forming Ingredients]:

The photosetting type bio-based coating composition according to the present invention comprises a bio-based photopolymerizable compound as a film-forming ingredient which compound has at least one lactic acid unit and at least one photopolymerizable group together in a molecule.

<Bio-Based Photopolymerizable Compound>:

The bio-based photopolymerizable compound has at least one lactic acid unit and at least one photopolymerizable group together in a molecule.

In the above, the number of photopolymerizable groups per one molecule of the bio-based photopolymerizable compound is favorably in the range of 1.2 to 30, more favorably 3.0 to 15. In cases where the number is smaller than 1.2, there is a worry that the curing density may be so low that such as scratch resistance or water resistance is poor. In cases where the number is larger than 30, there is a worry that the curing shrinkage may be so much that the adhesion is deteriorated.

In addition, the number-average molecular weight of the bio-based photopolymerizable compound is favorably in the range of 200 to 200,000, more favorably 500 to 50,000. In cases where the number-average molecular weight is less than 200, there is a worry that the bio-based content may be lowered. In cases where the number-average molecular weight is more than 200,000, there is a worry that the viscosity may be too high to be suitable for such as spray coating.

In addition, the photopolymerizable group equivalent (i.e. a value given by dividing the number-average molecular weight by the number of photopolymerizable groups per one molecule) of the bio-based photopolymerizable compound is favorably in the range of 200 to 5,000, more favorably 300 to 3,000. In cases where the photopolymerizable group equivalent is less than 200, there is a worry that the bio-based content may be lowered. In cases where the photopolymerizable group equivalent is more than 5,000, there is a worry that the crosslinking density may be too low, so that the coating film properties such as water resistance, alkali resistance, acid resistance, weather resistance, and scratch resistance may be deteriorated.

As to the above bio-based photopolymerizable compound, when the number of photopolymerizable groups is less than 3.0 or the photopolymerizable group equivalent is more than 3,000, it is favorable that in order to render the water resistance or alkali resistance sufficient, the structure of the compound contains a petroleum-based ingredient. In this case, the ratio of the petroleum-based ingredient is favorably in the range of 5 to 200 weight parts, more favorably 10 to 80 weight parts, per 100 weight parts of the bio-based ingredient. If the ratio is not less than 5 weight parts, then the aforementioned enhancement of the water resistance or alkali resistance is possible. However, if the ratio is more than 200 weight parts, then there is a worry that the bio-based content may be lowered.

Favorable examples of the photopolymerizable group include those which have a double bond such as (meth)acryloyl group and styryl group.

Since the bio-based photopolymerizable compound as used in the present invention has a lactic acid unit in a molecule, this compound can render the environmental load extremely low. In addition, since this compound has a photopolymerizable group in a molecule, the crosslinking during the film formation is photopolymerization crosslinking and is so dense as to give a high crosslinking density, so that it is made possible to obtain a film which is high in hardness and strength. Furthermore, as to the bio-based photopolymerizable compound as used in the present invention, since a film resultant therefrom is linked also by crosslinking, even if the polylactic acid moiety is cleaved due to hydrolysis during the use, there is the above linkage by crosslinking, so that the destruction of the whole film hardly occurs, and therefore the hydrolysis resistance is excellent.

Examples of the aforementioned bio-based photopolymerizable compound include a lactic acid macromonomer having a structure in which a photopolymerizable group is introduced at an end of a polylactic acid. Specifically, favorable examples include a compound in which as shown in the following formula (1), a photopolymerizable group X is introduced through a bond Y on a terminal carboxyl group side of a polylactic acid and a compound in which as shown in the following formula (2), a photopolymerizable group X is introduced through a bond Y on a terminal hydroxyl group side of a polylactic acid.

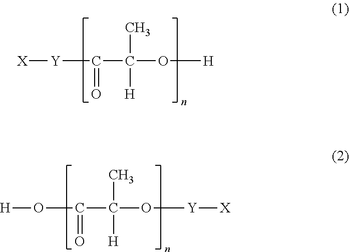

Hereupon, the structure moiety corresponding to the polylactic acid does not necessarily need to be that which consists of the lactic acid unit as shown in the above formulas (1) and (2), but the above structure moiety may contain another monomer component as a unit besides the lactic acid. Examples of the monomer other than the lactic acid include hydroxycarboxylic acids other than lactic acid, such as glycolic acid, 2-hydroxyisobutyric acid, methyl glycolate, methyl 2-hydroxyisobutyrate, and ethyl 2-hydroxyisobutyrate.

The aforementioned photopolymerizable group X is not especially limited. However, as mentioned above, (meth)acryloyl group, styryl group or those which contain either of them are favorable.

Preferable is a lactic acid macromonomer having a structure in which a hydroxyl group-containing monomer having a photopolymerizable group X and a hydroxyl group in an identical molecule (e.g. hydroxyalkyl(meth)acrylates) and a polylactic acid are bonded with each other, or a lactic acid macromonomer having a structure in which a carboxyl group-containing monomer having a photopolymerizable group X and a carboxyl group in an identical molecule (e.g. (meth)acrylic acid, fumaric acid, itaconic acid, maleic acid, crotonic acid, β-carboxyethyl acrylates) and a polylactic acid are bonded with each other. In this case, an ester bond is formed as the bond Y.

Particularly preferable is a lactic acid macromonomer as shown in the following formula (3) having a structure in which a hydroxyalkyl(meth)acrylate is ester-bonded to a terminal carboxyl group of a polylactic acid, or a lactic acid macromonomer as shown in the following formula (4) having a structure in which (meth)acrylic acid is ester-bonded to a terminal hydroxyl group of a polylactic acid. However, there is no limitation to these. In the following formulas (3) and (4), R¹ represents a hydrogen atom or a methyl group, and R² represents an alkyl group

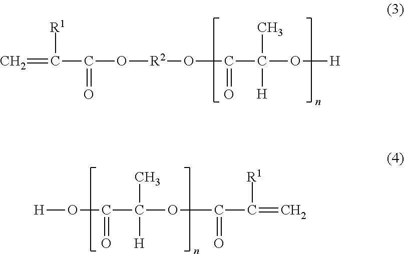

As to the aforementioned lactic acid macromonomer, the number “n” of lactic acid-repeating units in its structure is favorably in the range of 2 to 40. In cases where the number is smaller than 2, there is a worry that the bio-based content may be low. In cases where the number is larger than 40, there is a worry that the viscosity may be too high, so that the handling may be difficult. The number is more favorably in the range of 4 to 20.

In addition, the ratio of D-isomer/L-isomer of the lactic acid units as contained in the aforementioned lactic acid macromonomer is not especially limited. From the viewpoint of preventing the crystallization of the lactic acid macromonomer, the ratio is favorably in the range of 90/10 to 10/90.

Incidentally, the above explanation relates to the structure of the lactic acid macromonomer. The method for obtaining the lactic acid macromonomer is not limited to a method in which a polylactic acid is synthesized in advance, and into an end of the polylactic acid, a photopolymerizable group is introduced, but, for example, a method can also be adopted in which the synthesis of the polylactic acid and the introduction of the photopolymerizable group into an end of the polylactic acid can be carried out at the same time.

More specific examples of methods for obtaining the lactic acid macromonomer include the following:

(a) a method in which a lactic acid macromonomer is synthesized by mixing and heating a hydroxyl group-containing monomer with a lactide and thereby ring-opening-polymerizing the lactide on the hydroxyl group of the aforementioned monomer as a starting site;

(b) a method in which a lactic acid macromonomer is synthesized by mixing and heating a hydroxyl group-containing monomer or a carboxyl group-containing monomer with lactic acid and further, if necessary, such as another hydroxycarboxylic acid and thereby causing polyesterification of lactic acid and another hydroxycarboxylic acid and esterification of them with the aforementioned monomer at the same time; and

(c) a method in which a lactic acid macromonomer is synthesized by synthesizing a polylactic acid and then reacting it with a monomer capable of reacting with a terminal hydroxyl or carboxyl group of the polylactic acid (e.g. glycidyl(meth)acrylate capable of reacting with the terminal carboxyl group, and isocyanatoethyl(meth)acrylate capable of reacting with the terminal hydroxyl group).

In the above production methods, as to reaction conditions when obtaining the lactic acid macromonomer, the methods may be carried out appropriately in the presence of an inert solvent, and favorably, under an inert gas atmosphere such as in a nitrogen gas flow and in the absence of any solvent, or under dilution with a solvent such as toluene, xylene, butyl acetate, propylene glycol monomethyl ether acetate, diphenyl ether, or anisole.

In addition, the methods may be carried out appropriately in the presence of reaction catalysts and reaction promoters such as metal tin powder catalyst, organotin type catalysts (e.g. stannous octanoate, dibutyltin dilaurate, dibutyltin dioxide), phosphite type catalysts, organotitanium type catalysts (e.g. n-butyl ortho-titanate, n-isopropyl ortho-titanate), and there is no especial limitation.

In the case of obtaining a polylactic acid in advance, there is no especial limitation, and there can favorably be adopted a method in which the polylactic acid is obtained by carrying out a polycondensation reaction of such as D/L lactic acid or D/L alkyl lactate or lactide in an inert solvent usually at a reaction temperature of 80 to 200° C., favorably 110 to 150° C.

In addition, as to such as promoters and reaction conditions as used when carrying out a reaction in which a photopolymerizable group is introduced into an end of a polylactic acid or of its precursor, already publicly known methods may be used, and there is no especial limitation. Generally, in order to complete the reaction at a low temperature in a short time, for example, a reaction between a carboxyl group and a glycidyl group may be carried out under conditions where a tertiary amine or its salt is jointly used in an extremely small amount as a reaction catalyst.

In the above, a linear type lactic acid macromonomer is explained as the bio-based photopolymerizable compound. However, in order to enhance the crosslinking density by photopolymerization, it is preferable that the bio-based photopolymerizable compound has a branched type structure. Examples of such a branched type structure include the following:

(d) a branched type structure based on linkage between lactic acid units by a polyfunctional compound having a functionality of not less than 3; and

(e) a branched type structure based on formation of a side chain by homopolymerization of the lactic acid macromonomer as shown in the above formula (1) or (2) or copolymerization thereof with another monomer.

By the bio-based photopolymerizable compound having a branched type structure as shown in the above (d) or (e), a photopolymerizable group can be introduced into each of ends of the branched chains (in the above (e), it is also possible to introduce a photopolymerizable group into a functional group possessed by a side chain based on the comonomer). Therefore, the number of the photopolymerizable groups per one molecule is so large that the crosslinking by photopolymerization is very dense and therefore the resulting coating film is extremely excellent in the hydrolysis resistance.

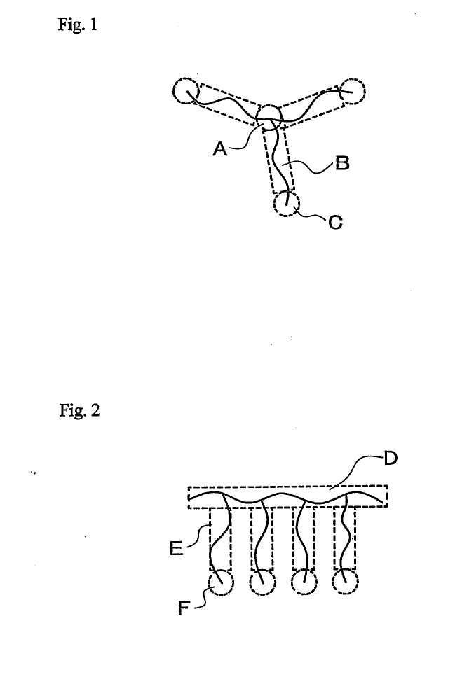

If the bio-based photopolymerizable compound having a branched type structure as shown in the above (d) or (e) is schematically shown, then as to the above (d), it is as shown in FIG. 1, and as to the above (e), it is as shown in FIG. 2. In FIG. 1, the site as shown by “A” is based on a polyfunctional compound (in FIG. 1, the functionality is 3), and the site as shown by “B” is based on a lactic acid ester structure, and the site as shown by “C” is a photopolymerizable group introduced into an end of a lactic acid ester structure. In FIG. 2, the site as shown by “D” is a principal chain formed by (co)polymerization of the lactic acid macromonomer or another comonomer, and the site as shown by “E” is a residue, as a side chain, of a structure which does not join the (co)polymerization, in the lactic acid macromonomer or another comonomer (in FIG. 2, only four side chains are drawn, but actually there will exist side chains in a number corresponding to the polymerization degree), and the site as shown by “F” is a photopolymerizable group introduced into an end of the side chain as shown by “E”.

In the above (d), the polyfunctional compound is not especially limited. Examples thereof include: branched type alcohols such as trimethylolpropane, pentaerythritol, glycerol, polyglycerol, and xylitol; polyhydric alcohols such as hydroxy(meth)acrylate-containing acrylic copolymers; aromatic carboxylic acids such as trimellitic acid; polycarboxylic acids such as (meth)acrylic acid-containing acrylic copolymers. Furthermore, examples also include compounds having a hydroxyl group and a carboxyl group in a molecule such as dimethylolpropanoic acid and dimethylolbutanoic acid. These compounds can be used alone respectively or in combinations with each other.

In cases where the lactic acid macromonomer is copolymerized with another monomer in the above (e), this comonomer is not especially limited. Examples thereof include those which have a vinyl group and those which have a (meth)acryloyl group. Specifically, examples include: alkyl or cycloalkyl(meth)acrylates such as methyl(meth)acrylate, ethyl(meth)acrylate, n-propyl(meth)acrylate, i-propyl(meth)acrylate, n-butyl(meth)acrylate, i-butyl(meth)acrylate, tert-butyl(meth)acrylate, n-hexyl(meth)acrylate, octyl(meth)acrylate, 2-ethylhexyl(meth)acrylate, nonyl(meth)acrylate, tridecyl(meth)acrylate, lauryl(meth)acrylate, stearyl(meth)acrylate, “isostearyl(meth)acrylate” (produced by Osaka Organic Chemicals Co., Ltd.), cyclohexyl(meth)acrylate, methylcyclohexyl(meth)acrylate, t-butylcyclohexyl(meth)acrylate, and cyclododecyl(meth)acrylate; polymerizable unsaturated monomers having an isobornyl group such as isobornyl(meth)acrylate; polymerizable unsaturated monomers having an adamantyl group such as adamantyl(meth)acrylate; polymerizable unsaturated monomers having an epoxy group such as glycidyl(meth)acrylate, β-methylglycidyl(meth)acrylate, 3,4-epoxycyclohexylmethyl(meth)acrylate, 3,4-epoxycyclohexylethyl(meth)acrylate, 3,4-epoxycyclohexylpropyl(meth)acrylate, and allyl glycidyl ether; aromatic vinyl monomers such as styrene, α-methylstyrene, vinyltoluene, and vinylbenzyl alcohol; polymerizable unsaturated monomers having an alkoxysilyl group such as vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane; siloxane macromonomers such as polydimethylsiloxane macromonomers; perfluoroalkyl(meth)acrylates such as perfluorobutylethyl(meth)acrylate and perfluorooctylethyl(meth)acrylate; polymerizable unsaturated monomers having an alkylfluorine group such as fluoroolefins; polymerizable unsaturated monomers having a photopolymerizable group such as a maleimide group; vinyl compounds such as N-vinylpyrrolidone, ethylene, butadiene, chloroprene, vinyl propionate, and vinyl acetate; polymerizable unsaturated monomers having a carboxyl group such as (meth)acrylic acid, fumaric acid, itaconic acid, maleic acid, crotonic acid, and β-carboxyethyl acrylate; unsaturated carboxylic anhydrides such as maleic anhydride and itaconic anhydride; nitrogen-containing polymerizable unsaturated monomers such as (meth)acrylonitrile, (meth)acrylamide, dimethylaminopropyl(meth)acrylamide, dimethylaminoethyl(meth)acrylate, and further, addition products between glycidyl(meth)acrylate and amines; polymerizable unsaturated monomers having a hydroxyl group such as (meth)acrylates having a polyoxyethylene chain of which the molecular end is a hydroxyl group; (meth)acrylates having a polyoxyethylene chain of which the molecular end is a alkoxy group; polymerizable unsaturated monomers having a sulfonic acid group such as 2-acrylamido-2-methlpropanesulfonic acid, allylsulfonic acid, sodium styrenesulfonate, sulfoethyl methacrylate and its sodium salts and ammonium salts; polymerizable unsaturated monomers having a ultraviolet absorbent functional group such as addition reaction products between glycidyl(meth)acrylate and hydroxybenzophenones (e.g. 2,4-dihydroxybenzophenones and 2,2′,4-trihydroxybenzophenones such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone), or 2-(2′-hydroxy-5′-methacryloyloxyethylphenyl)-2H-benzotriazole; ultraviolet-stable polymerizable unsaturated monomers such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine; polymerizable unsaturated monomers having a carbonyl group such as acrolein, diacetoneacrylamide, diacetonemethacrylamide, acetoacetoxyethyl(meth)acrylate, formylstyrol, vinyl alkyl ketones having 4 to 7 carbon atoms (e.g. vinyl methyl ketone, vinyl ethyl ketone, vinyl butyl ketone); polyvinyl compounds having at least two polymerizable functional groups in one molecule such as allyl(meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-trishydroxymethylethane di(meth)acrylate, 1,1,1-trishydroxymethylethane tri(meth)acrylate, 1,1,1-trishydroxymethylpropane tri(meth)acrylate, triallyl isocyanurate, diallyl terephthalate, and divinylbenzene; and fatty acid-modified polymerizable unsaturated monomers. These are used alone respectively or in combinations with each other depending on desired performances.

If methods for obtaining the above branched type bio-based photopolymerizable compounds are specified, then favorable examples thereof include the following:

(f) a method in which a branched type bio-based photopolymerizable compound is obtained by a process in which lactic acid is condensed in the presence of a polyhydric alcohol such as trimethylolpropane to thereby form a branched type polylactic acid, and then to its terminal hydroxyl group, there is added by reaction a compound having a carboxyl group and a photopolymerizable double bond such as (meth)acrylic acid;

(g) a method in which a branched type bio-based photopolymerizable compound is obtained by a process in which to a terminal hydroxyl group of the aforementioned branched type polylactic acid, there is added by reaction, for example, an acid anhydride such as succinic anhydride, and then thereto there is further added by reaction a compound having a cyclic ether and a photopolymerizable double bond such as glycidyl(meth)acrylate;

(h) a method in which a branched type bio-based photopolymerizable compound is obtained by a process in which a condensation reaction between a polycarboxylic acid (e.g. trimellitic anhydride, hydrogenated trimellitic anhydride) and lactic acid is carried out to synthesize a carboxyl group-terminated branched type polylactic acid, and then to its terminal carboxyl group, there is added by reaction a compound having a hydroxyl group and a photopolymerizable double bond such as hydroxyethyl(meth)acrylate;

(i) a method in which a branched type bio-based photopolymerizable compound is obtained by a process in which to a terminal carboxyl group of a branched type polylactic acid, there is added by reaction a compound having a cyclic ether and a photopolymerizable double bond such as glycidyl(meth)acrylate; and

(j) a method in which a branched type bio-based photopolymerizable compound having a comparatively high molecular weight is obtained by a process in which a lactic acid macromonomer having a double bond at an end of a polylactic acid is synthesized by a publicly known method in advance and then copolymerized with such as another acrylic monomer, and then into the formed copolymer, there is introduced a photopolymerizable double bond by the aforementioned method.

<Other Film-Forming Ingredients>:

Examples of other film-forming ingredients include: acrylic monomers such as ethyl(meth)acrylate, butyl(meth)acrylate, ethylhexyl(meth)acrylate, 2-hydroxyethyl(meth)acrylate, tetrahydrofurfuryl(meth)acrylate, 1,4-butanediol(meth)acrylate, 1,6-hexanediol(meth)acrylate, 1,9-nonanediol(meth)acrylate, neopentyl glycol di(meth)acrylate, bis(2-acryloyloxyethyl)isocyanurate, tris(2-acryloyloxyethyl)isocyanurate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, and dipentaerythritol hexa(meth)acrylate; oligomers formed by polymerization of these acrylic monomers; or urethane(meth)acrylates synthesized by addition reactions of polyhydric alcohols with polyfunctional isocyanates and hydroxyl group-containing (meth)acrylate compounds; polyester(meth)acrylates synthesized by condensation reactions of polyhydric alcohols with (meth)acrylic acid and polyfunctional carboxylic acids; and epoxy(meth)acrylates synthesized by addition reactions of bisphenol type epoxy resins or novolac type epoxy resins with (meth)acrylic acid. In addition, photopolymerizable group-containing inorganic fine particles synthesized by treating inorganic fine particles such as colloidal silica with (meth)acryloyl group-containing silane coupling agents may be used. These can be used alone respectively or in combinations with each other.

In addition, it is also possible to jointly use a polymer having a photopolymerizable group introduced into a side chain of an acrylic resin or a polymer having a photopolymerizable group introduced into an end and/or a side chain of a polyurethane resin.

[Photopolymerization Initiator]:

The photosetting type bio-based coating composition according to the present invention contains a photopolymerization initiator.

As the photopolymerization initiator, any can be used if it can initiate photopolymerization based on a photopolymerizable group of the photopolymerizable bio-based compound by irradiation of light. Specifically, examples thereof include carbonyl compounds such as benzoin, benzoin monomethyl ether, benzoin isopropyl ether, acetoin, benzyl, benzophenone, p-methoxybenzophenone, diethoxyacetophenone, benzyl dimethyl ketal, 2,2-diethoxyacetophenone, 1-hydroxycyclohexyl phenyl ketone, methylphenyl glyoxylate, ethylphenyl glyoxylate, and 2-hydroxy-2-methyl-1-phenylpropan-1-one; sulfur compounds such as tetramethylthiuram monosulfide and tetramethylthiuram disulfide; and acylphosphine oxides such as 2,4,6-trimethylbenzoyldiphenylphosphine oxide. These can be used alone respectively or in combinations with each other.

[Other Ingredients]:

Within the range where the effects of the present invention are not damaged, the photosetting type bio-based coating composition according to the present invention may contain other ingredients, for example, those which are explained below.

As photostabilizing agents, publicly known hindered amine type photostabilizing agents can be used. Specifically, examples thereof include: bis(2,2,6,6-tetramethyl-4-piperidinyl)sebacate, bis(1,2,2,6,6-pentamethyl-4-piperidinyl)sebacate, bis(1-methoxy-2,2,6,6-tetramethyl-4-piperidinyl)sebacate, bis(1-ethoxy-2,2,6,6-tetramethyl-4-piperidinyl)sebacate, bis(1-propoxy-2,2,6,6-tetramethyl-4-piperidinyl)sebacate, bis(1-butoxy-2,2,6,6-tetramethyl-4-piperidinyl)sebacate, bis(1-pentyloxy-2,2,6,6-tetramethyl-4-piperidinyl)sebacate, bis(1-hexyloxy-2,2,6,6-tetramethyl-4-piperidinyl)sebacate, bis(1-heptyloxy-2,2,6,6-tetramethyl-4-piperidinyl)sebacate, bis(1-octoxy-2,2,6,6-tetramethyl-4-piperidinyl)sebacate, bis(1-nonyloxy-2,2,6,6-tetramethyl-4-piperidinyl)sebacate, bis(1-decanyloxy-2,2,6,6-tetramethyl-4-piperidinyl)sebacate, and bis(1-dodecyloxy-2,2,6,6-tetramethyl-4-piperidinyl)sebacate.

In addition, examples of the photostabilizing agent also include: ultraviolet absorbing agents such as 2-(2-hydroxy-5-t-butylphenyl)-2H-benzotriazole, octyl-3-[3-tert-butyl-4-hydroxy-5-(5-chloro-2H-benzotriazole-2-yl)phenyl]propionate, 2-ethylhexyl-3-[3-tert-butyl-4-hydroxy-5-(5-chloro-2H-benzotriazole-2-yl)phenyl]propionate, 2-(2H-benzotriazole-2-yl)-4,6-bis(1-methyl-1-phenylethyl)phenol, 2-(2H-benzotriazole-2-yl)-6-(1-methyl-1-phenylethyl)-4-(1,1,3,3-tetramethylbutyl)phenol, 2-[4-(octyl-2-methylethanoate)oxy-2-hydroxyphenyl]-4,6-[bis(2,4-dimethylphenyl)]-1,3,5-triazine, tris[2,4,6-[2-[4-(octyl-2-methylethanoate)oxy-2-hydroxyphenyl]]-1,3,5-triazine, and 2-(2-hydroxy-4-[1-octyloxycarbonylethoxy]phenyl)-4,6-bis(4-phenylphenyl)-1,3,5-triazine.

The coating composition according to the present invention can be applied to both of aqueous type and organic solvent type. Therefore, as the solvent, any of water, an organic solvent and a mixed solvent of them can be used.

Examples of the organic solvent include: lactones such as γ-butyrolactone, γ-valerolactone, γ-caprolactone, γ-heptalactone, α-acetyl-γ-butyrolactone, and ε-caprolactone; ethers such as dioxane, 1,2-dimethoxymethane, diethylene glycol dimethyl ether, diethylene glycol diethyl ether, diethylene glycol dibutyl ether, propylene glycol monomethyl ether, propylene glycol monoethyl ether, triethylene glycol dimethyl ether, triethylene glycol diethyl ether, tetraethylene glycol dimethyl ether, and tetraethylene glycol diethyl ether; carbonates such as ethylene carbonate and propylene carbonate; ketones such as methyl ethyl ketone, methyl isobutyl ketone, cyclohexanone, and acetophenone; phenols such as phenol, cresol, and xylenol; esters such as ethyl acetate, butyl acetate, methyl lactate, ethyl cellosolve acetate, butyl cellosolve acetate, carbitol acetate, butyl carbitol acetate, and propylene glycol monomethyl ether acetate; hydrocarbons such as toluene, xylene, diethylbenzene, and cyclohexane; halogenated hydrocarbons such as trichloroethane, tetrachloroethane, and monochlorobenzene; organic solvents such as petroleum type solvents (e.g. petroleum ether, petroleum naphtha); fluoro-alcohols such as 2H,3H-tetrafluoropropanol; hydrofluoroethers such as perfluorobutyl methyl ether and perfluorobutyl ethyl ether; alcohols such as methyl alcohol, ethyl alcohol, isopropyl alcohol, and n-propyl alcohol; and diacetone alcohols combing performances of both of ketone and alcohol.

From the viewpoint of environmental protection, it is favorable that a bio-based solvent is contained in the organic solvent. Examples of the bio-based solvent include such as methyl lactate, ethyl lactate, and ethanol.

The coating composition according to the present invention may, if necessary, further contain conventional known coloring agents. Examples thereof include natural colors, organic pigments, inorganic pigments, extenders, electroconductive pigments, and metallic pigments. The aforementioned coloring agents are not limited to those which are dispersed into solvents, but may be those which are dissolved into solvents.

Examples of the aforementioned natural colors include carotenoid colors, flavonoid colors, flavin colors, quinone colors, porphyrin colors, diketone colors, and betacyanidin colors. Examples of the aforementioned carotenoid colors include carotene, carotenal, capsanthin, lycopene, bixin, crocin, canthaxanthin and annatto. Examples of the aforementioned flavonoid colors include: anthocyanidins such as shisonin, raphanin and enociana; chalcones such as safrole yellow and saflower; flavonols such as rutin and quercetin; and flavones such as cacao colors. Examples of the aforementioned flavin colors include riboflavin. Examples of the aforementioned quinone colors include: anthraquinones such as laccaic acid, carminic acid (cochineal), kermesic acid and alizarin; and naphthoquinones such as shikonin, alkhanin and ehinochrome. Examples of the aforementioned porphyrin colors include chlorophyll and blood color. Examples of the aforementioned diketone colors include curcumin (turmeric). Examples of the aforementioned betacyanidin colors include betanin.

Examples of the aforementioned organic pigments include azolake pigments, insoluble azo pigments, condensed azo pigments, phthalocyanine pigments, indigo pigments, perinone pigments, perylene pigments, phthalon pigments, dioxazine pigments, quinacridone pigments, isoindolinone pigments, benzimidazolone pigments, diketopyrrolopyrrole pigments, and metal complex pigments (e.g. phthalocyanine blue, phthalocyanine green, carbazole violet, anthrapyrimidine yellow, flavanthrone yellow, isoindoline yellow, indanthron blue and quinacridone violet).

Examples of the aforementioned inorganic pigments include yellow iron oxide, red iron oxide, carbon black, titanium dioxide, chromium oxide, lead chromate, chrome yellow and Prussian blue.

Examples of the aforementioned extenders include talc, calcium carbonate, precipitated barium sulfate, and silica.

Examples of the aforementioned electroconductive pigments include electroconductive carbon, and whisker coated with antimony-doped tin oxide.

Examples of the aforementioned metallic pigments include aluminum flakes, copper bronze flakes, mica-shaped iron oxide, mica flakes, mica-shaped iron oxide coated with metal iron oxide, and mica flakes coated with metal iron oxide.

The aforementioned coloring agents may be used either alone respectively or in combinations with each other.

The coating composition according to the present invention may, if necessary, further contain conventional known additives. Examples thereof include surface conditioners, rheology control agents, pinhole inhibitors, antisagging agents, antioxidants, matting agents, burnishing agents, antiseptic agents, curing promoters, curing catalysts, scratch inhibitors, and defoaming agents.

<Mixing of Ingredients>:

The ratio between the bio-based photopolymerizable compound and another photopolymerizable compound is favorably in the range of 100/0 to 20/80, more favorably 90/10 to 40/60, by weight of nonvolatiles. In cases where the ratio of the other photopolymerizable compound is too much, there is a worry that the bio-based content may be low, and that the surface gloss peculiar to lactic acid may be low.

The photopolymerization initiator is used favorably in a ratio of 0.1 to 20 weight parts, more favorably 0.5 to 10 weight parts, per 100 weight parts of nonvolatiles of the photopolymerizable compounds. In cases where the ratio is less than 0.1 weight part, there is a worry that the reaction may be so insufficient as to result in a low crosslinking density. In cases where the ratio is more than 20 weight part, there is a worry that due to the photopolymerization initiator remaining in a coating film and a decomposed product from the photopolymerization initiator, a bad smell nay be generated or coating film properties such as chemical resistance or water resistance may be deteriorated.

The photostabilizing agent is used favorably in a ratio of 0.1 to 20 weight parts, more favorably 0.3 to 10 weight parts, per 100 weight parts of nonvolatiles of the photopolymerizable compounds. In cases where the ratio is less than 0.1 weight part, there is a worry that the deterioration of a coating film may proceed. In cases where the ratio is more than 20 weight part, there is a worry that the amount of the photostabilizing agent remaining in a coating film may be so large as to deteriorate coating film properties such as hardness, chemical resistance or water resistance may be deteriorated.

The coloring agent is used favorably in a ratio of 0.001 to 400 weight parts, more favorably 0.01 to 200 weight parts, per 100 weight parts of nonvolatiles of the photopolymerizable compounds.

As additives other than the photostabilizing agent, there may be contained various additives such as bluing agents, pigments, leveling agents, defoaming agents, thickeners, sedimentation inhibitors, antistatic agents, and clouding inhibitors within the range not damaging the coating film properties.

These coating film-forming ingredients are used usually in the form dissolved or dispersed in a solvent and/or water. The dilution ratio and the viscosity depend on coating methods, but the nonvolatile content is favorably not less than 5%, more favorably not less than 15%. In cases where the nonvolatile content is less than 5%, there is a worry that the coating efficiency may be low, and that the solvent may need to be used in such a large amount as to be unfavorable for environment.

[Coated Article]:

The coated article according to the present invention is obtained by being coated with the aforementioned coating composition according to the present invention.

The coating can, for example, be carried out by a process in which the coating composition is coated onto a base material (to be coated) by methods such as brush coating, spray coating, dip coating, spin coating, and curtain coating and then irradiated with light, thereby being crosslinked to form a cured coating film. In this case, the coating composition is coated onto the base material (to be coated) so that the film thickness will be favorably in the range of 1 to 50 μm, more favorably 3 to 30 μm, and then irradiated usually with ultraviolet rays of 100 to 400 nm so as to be 200 to 4,000 mJ/cm² using such as a high pressure mercury lamp or a metal halide lamp. The atmosphere in which the irradiation is made may be air or an inert gas such as nitrogen or argon.

The base material to be coated with the coating composition according to the present invention is not especially limited, but is exemplified by plastics, metals, glass, ceramics, wood, plants, rocks, and sand. Particularly, the coating composition can be used for modification of surfaces of such as various synthetic resin moldings. Favorable examples of the synthetic resin moldings include various thermoplastic resins and thermosetting resins of which such as abrasion resistance or weather resistance have hitherto been desired to be improved. Specific examples thereof include poly(methyl methacrylate) resins, polycarbonate resins, polyester resins, poly(polyester)carbonate resins, polystyrene resins, ABS resins, AS resins, polyamide resins, polyallylate resins, polymethacrylimide resins, polyally diglycol carbonate resins, and polylactic acid resins. Hereupon, the synthetic resin moldings are such as sheet moldings comprising these resins, film moldings, and various injection moldings.

The coating composition according to the present invention is, for example, coated onto the above base material to be coated, and thereby can favorably be used as such as adhesives, pressure sensitive adhesives, pressure sensitive adhesive-adhesive transfer type adhesives, coatings for plastics and metals, inks for paper, and aqueous inks. Particularly, the coating composition according to the present invention is excellent in uses as coatings, wherein the coatings are not limited to those for the purpose of surface-protecting or surface-decorating effects, but also include special coatings provided with other purposes such as electroconductive coatings, insulating coatings, and fire-resistant coatings.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to these.

### Synthesis Example 1

A separable flask of 2 L in capacity as equipped with a thermostat, a stirring blade, a nitrogen-introducing inlet, a dean-stark trap and a reflux condenser was charged with 22.6 g of trimethylolpropane, 727.4 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours. After it had been confirmed that the acid value of the resin had become not more than 4 mgKOH/g (resin nonvolatile), the temperature was dropped to 100° C. and kept constant thereat. Thereto, 0.35 g of p-toluenesulfonic acid, 5.0 g of methoxyhydroquinone, and 52.0 g of acrylic acid were added to continue the reaction for 12 hours. The resultant acid value was not more than 2 mgKOH/g (resin nonvolatile), and therefrom it could be confirmed that almost the whole amount of acrylic acid had reacted. The xylene was removed by reducing the pressure. After cooling, a mixture of 10 g of dimethylethanolamine and 1,000 g of ion-exchanged water was added, and stirring was carried out, and then the water phase was removed, thus obtaining a branched type bio-based photopolymerizable compound of 3 in functionality (nonvolatile content: 100%), of which the number-average molecular weight was 3,780 and the double bond equivalent (photopolymerizable group equivalent) was 1,260.

### Synthesis Example 2

The same reactor as of Synthesis Example 1 was charged with 33.8 g of pentaerythritol, 716.2 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours, and it had been confirmed that the acid value of the resin had become 4 mgKOH/g (resin nonvolatile). Next, the xylene and a very small amount of water were removed by reducing the pressure, and then the temperature was dropped to 140° C. Thereto, 89.52 g of succinic anhydride added to continue the reaction for 3 hours, so that it was confirmed by infrared spectrograph that the acid anhydride had disappeared. Next, the temperature was dropped to 90° C., and then 1.0 g of methoxyhydroquinone and 114.4 g of glycidyl methacrylate were added to continue the reaction for 6 hours. The resultant acid value was not more than 2.3 mgKOH/g (resin nonvolatile), and therefore almost the whole amount of glycidyl methacrylate had made the addition reaction, thus obtaining a branched type bio-based photopolymerizable compound of about 3.2 in average functionality (nonvolatile content: 100%), of which the number-average molecular weight was 3,690 and the double bond equivalent was 1,153.

### Synthesis Example 3

The same reactor as of Synthesis Example 1 was charged with 126.4 g of adipic acid, 623.6 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours. After it had been confirmed that the acid value of the resin had become not more than 4 mgKOH/g (resin nonvolatile), the temperature was dropped to 100° C. and kept constant thereat. Thereto, 0.35 g of p-toluenesulfonic acid, 5.0 g of hydroquinone, and 212.0 g of hydroxyethyl acrylate were added to continue the reaction for 12 hours. The resultant acid value was not more than 2 mgKOH/g (resin nonvolatile), and therefrom it could be confirmed that almost the whole amount of the added hydroxyethyl acrylate had reacted. The xylene and unreacted hydroxyethyl acrylate were removed by reducing the pressure. After cooling, a mixture of 10 g of dimethylethanolamine and 1,000 g of ion-exchanged water was added, and stirring was carried out, and then the water phase was removed, thus obtaining a branched type bio-based photopolymerizable compound of 2 in functionality (nonvolatile content: 100%), of which the number-average molecular weight was 1,010 and the double bond equivalent was 505.

### Synthesis Example 4

The same reactor as of Synthesis Example 1 was charged with 90.4 g of hydrogenated trimellitic acid, 659.6 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours, and it had been confirmed that the acid value of the resin had become 4 mgKOH/g (resin nonvolatile). Next, the xylene and a very small amount of water were removed by reducing the pressure, and then the temperature was dropped to 95° C. Thereto, 1.0 g of methoxyhydroquinone and 138.7 g of glycidyl methacrylate were added to continue the reaction for 6 hours. The resultant acid value was 3.3 mgKOH/g (resin nonvolatile), and therefore almost the whole amount of glycidyl methacrylate had made the addition reaction, thus obtaining a branched type bio-based photopolymerizable compound of about 2.7 in average functionality (nonvolatile content: 100%), of which the number-average molecular weight was 3,690 and the double bond equivalent was 1,367.

### Synthesis Example 5

The same reactor of 1 L in capacity as of Synthesis Example 1 was charged with 138.8 g of hydroxyethyl methacrylate, 461.2 g of L-lactide, 0.6 g of tin octylate, and 0.12 g of methoxyhydroquinone, and a reaction was continued at 100° C. for 3 hours, thereby obtaining a macromonomer of lactic acid hexamer from the measurement of its molecular weight.

Next, a reactor of 1 L in capacity as equipped with a thermostat, a stirring blade, a nitrogen-introducing inlet, a dropping funnel and a reflux condenser was charged with 360 g of butyl acetate, and the temperature was kept at 100° C. Thereto, a mixed liquid of 240 g of the aforementioned macromonomer, 160 g of glycidyl methacrylate, and 10 g of azobisisobutyronitrile was dropwise added over a period of 3 hours. Then, 1 hour later, a mixed liquid of 1.0 g of azobisisobutyronitrile and 40 g of butyl acetate was dropwise added over a period of 30 minutes. Then, 1 hour later, the temperature was dropped to 90° C. Thereto, 0.1 g of methoxyhydroquinone and 72 g of acrylic acid were added to continue the reaction for 5 hours. The resultant acid value was almost zero, and therefrom it was confirmed that almost the whole amount of the added acrylic acid had made the addition reaction. The resultant bio-based photopolymerizable compound (nonvolatile content: 100%) had a number-average molecular weight of 10,500 and a double bond equivalent of 472.

### Synthesis Example 6

A reactor of 1 L in capacity as equipped with a thermostat, a stirring blade, a nitrogen-introducing inlet, a dropping funnel and a reflux condenser was charged with 360 g of butyl acetate, and the temperature was kept at 100° C. Thereto, a mixed liquid of 160 g of t-butyl methacrylate, 160 g of methacrylic acid, 80 g of “FM-2” (produced by Daicel Chemical Industries, Ltd.), and 10 g of azobisisobutyronitrile was dropwise added over a period of 3 hours. Then, 1 hour later, a mixed liquid of 1.0 g of azobisisobutyronitrile and 40 g of butyl acetate was dropwise added over a period of 30 minutes. Then, 1 hour later, the temperature was dropped to 90° C. Thereto, 0.1 g of methoxyhydroquinone, 12 g of triethyamine and 184.9 g of glycidyl methacrylate were added to continue the reaction for 5 hours. The resultant acid value was 54, and therefrom it was confirmed that almost the whole amount of the added glycidyl methacrylate had made the addition reaction. The resultant photopolymerizable acrylic resin (nonvolatile content: 50%) had a number-average molecular weight of 13,200 and a double bond equivalent of 450.

### Synthesis Example 7

The same reactor as of Synthesis Example 6 was charged with 330 g of propylene glycol monomethyl ether acetate, 204 g of “T-4671” (polycarbonate diol, produced by Asahi Kasei Corporation), 59.6 g of pentaerythritol triacrylate, and 0.2 g of dibutyltin laurate, and the temperature was raised to 80° C. Thereto, 66.6 g of isophorone diisocyanate was added to continue the reaction for 2 hours, and then the temperature was raised to 120° C. to continue the reaction for another 2 hours. At that point of time, in the infrared absorption spectrum, the absorption by the isocyanate was not observed. The resultant photopolymerizable urethane resin (nonvolatile content: 50%) had a number-average molecular weight of 3,390 and a double bond equivalent of 565.

### Synthesis Example 8

The same reactor as of Synthesis Example 1 was charged with 33.8 g of pentaerythritol, 716.2 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours, and it had been confirmed that the acid value of the resin had become 4 mgKOH/g (resin nonvolatile). Next, the temperature was dropped to 90° C., and then 1.0 g of methoxyhydroquinone and 119.2 g of 3-carboxystyrene were added to continue the reaction for 6 hours. The resultant acid value was 2.4 mgKOH/g (resin nonvolatile), and therefore almost the whole amount of 3-carboxystyrene had made the addition reaction, thus obtaining a branched type bio-based photopolymerizable compound of about 3.2 in average functionality (nonvolatile content: 100%), of which the number-average molecular weight was 2,970 and the double bond equivalent was 741.

### Synthesis Example 9

The same reactor as of Synthesis Example 1 was charged with 22.6 g of trimethylolpropane, 727.4 g of L-lactic acid (produced by Purac Ltd.), 50 g of xylene, and 0.15 g of p-toluenesulfonic acid. In addition, the dean-stark trap was filled with xylene to the upper limit. Under a nitrogen gas flow, the temperature in the system was raised to 140° C., which was retained for 1 hour. Furthermore, the temperature in the system was raised to 175° C., and a condensation reaction was continued for 5 hours. After it had been confirmed that the acid value of the resin had become not more than 4 mgKOH/g (resin nonvolatile), the temperature was dropped to 100° C. and kept constant thereat. Thereto, 0.35 g of p-toluenesulfonic acid, 5.0 g of methoxyhydroquinone, and 75.0 g of cinnamic acid were added to continue the reaction for 12 hours. The resultant acid value was not more than 2 mgKOH/g (resin nonvolatile), and therefrom it could be confirmed that almost the whole amount of the cinnamic acid had reacted. The xylene was removed by reducing the pressure. After cooling, a mixture of 10 g of dimethylethanolamine and 1,000 g of ion-exchanged water was added, and stirring was carried out, and then the water phase was removed, thus obtaining a branched type bio-based photopolymerizable compound of 4 in functionality (nonvolatile content: 100%), of which the number-average molecular weight was 3,860 and the double bond equivalent was 965.

### Example 1

An amount of 70.0 g of the bio-based photopolymerizable compound of Synthesis Example 1, 60.0 g of the photopolymerizable acrylic resin of Synthesis Example 6, 4.0 g of “Irgacure 184” (produced by Ciba Specialty Chemicals), 2.0 g of “Tinuvin 400” (produced by Ciba Specialty Chemicals), 1.0 g of “Tinuvin 292” (produced by Ciba Specialty Chemicals), 0.2 g of “BYK 333” (produced by BYK Chemie), and 270.0 g of butyl acetate were mixed together until becoming uniform and transparent, and the resultant mixture was spray-coated onto an ABS base material so as to form a coating film having a thickness of 30±3μ.

After the coating, the material was left at room temperature for 10 minutes, and then heat-treated at 80° C. in an oven for 3 minutes to thereby volatilize the organic solvent, and then irradiated with an energy of 400 mL/cm² in integrated quantity of light of 340 to 380 nm in wavelength using a high pressure mercury lamp in air, thus obtaining a cured coating film.

The evaluation of the coating film was carried out after 24 hours had passed since the completion of the drying.

### Example 2

A cured coating film was obtained in the same way as of Example 1 except that the formulation of the coating composition was changed into 70.0 g of the bio-based photopolymerizable compound of Synthesis Example 2, 60.0 g of the photopolymerizable urethane resin of Synthesis Example 7, 4.0 g of “Irgacure 184”, 2.0 g of “Tinuvin 400”, 1.0 g of “Tinuvin 292”, 0.2 g of “BYK 333”, 100.0 g of ethanol, and 170.0 g of ethyl lactate.

### Example 3

A cured coating film was obtained in the same way as of Example 1 except that the formulation of the coating composition was changed into 100.0 g of the bio-based photopolymerizable compound of Synthesis Example 2, 4.0 g of “Irgacure 184”, 2.0 g of “Tinuvin 400”, 1.0 g of “Tinuvin 292”, 0.2 g of “BYK 333”, and 300.0 g of butyl acetate.

### Example 4

A cured coating film was obtained in the same way as of Example 1 except that the formulation of the coating composition was changed into 50.0 g of the bio-based photopolymerizable compound of Synthesis Example 3, 40.0 g of the photopolymerizable urethane resin of Synthesis Example 7, 30.0 g of “SR 295” (pentaerythritol tetraacrylate, nonvolatile content: 100%, produced by Sartomer), 4.0 g of “Irgacure 184”, 2.0 g of “Tinuvin 400”, 1.0 g of “Tinuvin 292”, 0.2 g of “BYK 333”, and 280.0 g of methyl lactate.

### Example 5

An amount of 70.0 g of the bio-based photopolymerizable compound of Synthesis Example 4, 60.0 g of the photopolymerizable acrylic resin of Synthesis Example 6, 4.0 g of “Irgacure 184”, 4.5 g of triethylamine, 0.05 g of dibutyltin laurate, 0.50 g of “Polyflow KL-245” (produced by Kyoeisha Kagaku), and 0.30 g of “Surfynol 104PA” (produced by Air Products) were mixed together until becoming uniform, and thereinto 270.0 g of ion-exchanged water was mixed to obtain a water dispersion of a resin.

This was spray-coated onto an ABS base material so as to form a coating film having a thickness of 30±3μ.

After the coating, the material was left at room temperature for 10 minutes, and then heat-treated at 80° C. in an oven for 3 minutes to thereby volatilize the solvent, and then irradiated with an energy of 400 mL/cm² in integrated quantity of light of 340 to 380 nm in wavelength using a high pressure mercury lamp in air, thus obtaining a cured coating film.

The evaluation of the coating film was carried out after 24 hours had passed since the completion of the drying.

### Example 6

A cured coating film was obtained in the same way as of Example 1 except that the formulation of the coating composition was changed into 50.0 g of the bio-based photopolymerizable compound of Synthesis Example 5, 30.0 g of “SR 295”, 4.0 g of “Irgacure 184”, 2.0 g of “Tinuvin 400”, 1.0 g of “Tinuvin 292”, 0.2 g of “BYK 333”, and 320.0 g of butyl acetate.

### Example 7

A cured coating film was obtained in the same way as of Example 1 except that the formulation of the coating composition was changed into 100.0 g of the bio-based photopolymerizable compound of Synthesis Example 3, 4.0 g of “Irgacure 184”, 2.0 g of “Tinuvin 400”, 1.0 g of “Tinuvin 292”, 0.2 g of “BYK 333”, 300.0 g of methyl lactate.

### Example 8

A cured coating film was obtained in the same way as of Example 1 except that the formulation of the coating composition was changed into 70.0 g of the bio-based photopolymerizable compound of Synthesis Example 8, 60.0 g of the photopolymerizable urethane resin of Synthesis Example 7, 4.0 g of “Irgacure 184”, 2.0 g of “Tinuvin 400”, 1.0 g of “Tinuvin 292”, 0.2 g of “BYK 333”, 100.0 g of ethanol, and 170.0 g of ethyl lactate.

### Comparative Example 1

A cured coating film was obtained in the same way as of Example 1 except that the formulation of the coating composition was changed into 60.0 g of the photopolymerizable acrylic resin of Synthesis Example 6, 70.0 g of “SR 295”, 4.0 g of “Irgacure 184”, 2.0 g of “Tinuvin 400”, 1.0 g of “Tinuvin 292”, 0.2 g of “BYK 333”, and 270.0 g of butyl acetate.

### Comparative Example 2

A cured coating film was obtained in the same way as of Example 1 except that the formulation of the coating composition was changed into 60.0 g of the photopolymerizable urethane resin of Synthesis Example 7, 70.0 g of “SR 295”, 4.0 g of “Irgacure 184”, 2.0 g of “Tinuvin 400”, 1.0 g of “Tinuvin 292”, 0.2 g of “BYK 333”, and 270.0 g of butyl acetate.

### Comparative Example 3

A cured coating film was obtained in the same way as of Example 1 except that the formulation of the coating composition was changed into 70.0 g of the bio-based photoreactive compound of Synthesis Example 9, 60.0 g of the photopolymerizable acrylic resin of Synthesis Example 6, 4.0 g of “Irgacure 184”, 2.0 g of “Tinuvin 400”, 1.0 g of “Tinuvin 292”, 0.2 g of “BYK 333”, and 270.0 g of butyl acetate.

[Evaluation Results]:

The results of coating film performance evaluation which was carried out as to the above test pieces according to Examples 1 to 8 and Comparative Examples 1 to 3 are shown in Table 1 together with the main formulations of the coating compositions as used for the coating films (it is noted that the ratios of the photopolymerizable compounds are shown in terms of nonvolatiles).

TABLE 1

| | | | | | | | | | | | Com. | Com. | Com. |
|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 1 | Ex. 2 | Ex. 3 |
| Formula- | Photo- | Syn. Ex. 1 | 70.0 | | | | | | | | | | |
| tion | polymerizable | Syn. Ex. 2 | | 70.0 | 100.0 | | | | | | | | |
| | resin | Syn. Ex. 3 | | | | 50.0 | | | 100.0 | | | | |
| | (in terms of | Syn. Ex. 4 | | | | | 70.0 | | | | | | |
| | nonvolatiles) | Syn. Ex. 5 | | | | | | 70.0 | | | | | |
| | | Syn. Ex. 6 | 30.0 | | | | 30.0 | | | | 30.0 | | 30.0 |
| | | Syn. Ex. 7 | | 30.0 | | 20.0 | | | | 30.0 | | 30.0 | |
| | | Syn. Ex. 8 | | | | | | | | 70.0 | | | |
| | | Syn. Ex. 9 | | | | | | | | | | | 70.0 |
| | | SR295 | | | | 30.0 | | 30.0 | | | 70.0 | 70.0 | |
| | Photo- | Irgacure 184 | 4.0 | 4.0 | 4.0 | 4.0 | 4.0 | 4.0 | 4.0 | 4.0 | 4.0 | 4.0 | 4.0 |
| | poly- | | | | | | | | | | | | |
| | merization | | | | | | | | | | | | |
| | initiator | | | | | | | | | | | | |
| | Photo- | Tinuvin 400 | 2.0 | 2.0 | 2.0 | 2.0 | 2.0 | 2.0 | 2.0 | 2.0 | 2.0 | 2.0 | 2.0 |
| | stabilizing | Tinuvin 292 | 1.0 | 1.0 | 1.0 | 1.0 | 1.0 | 1.0 | 1.0 | 1.0 | 1.0 | 1.0 | 1.0 |
| | agent | | | | | | | | | | | | |
| | Surface | BYK333 | 0.2 | 0.2 | 0.2 | 0.2 | 0.2 | 0.2 | 0.2 | 0.2 | 0.2 | 0.2 | 0.2 |
| | conditioner | | | | | | | | | | | | |

| Type of coating composition | | Solvent | Solvent | Solvent | Solvent | Aqueous | Solvent | Solvent | Solvent | Solvent | Solvent | Solvent |
|---|---|---|---|---|---|---|---|---|---|---|---|---|
| | | type | type | type | type | | type | type | type | type | type | type |
| Coating | Appearance | ◯ | ◯ | ◯ | ◯ | ◯ | ◯ | ◯ | ◯ | ◯ | ◯ | ◯ |
| film | 60° Gloss | ◯ | ◯ | ◯ | ◯ | ◯ | ◯ | ◯ | ◯ | ◯ | ◯ | X |
| per- | Initial adhesion | ◯ | ◯ | ◯ | ◯ | ◯ | ◯ | ◯ | ◯ | ◯ | ◯ | X |
| formance | Humidity resistance | ◯ | ◯ | ◯ | ◯ | ◯ | ◯ | Δ | ◯ | ◯ | ◯ | X |
| | Alkali resistance | ◯ | ◯ | ◯ | ◯ | ◯ | ◯ | Δ | ◯ | ◯ | ◯ | X |
| | Water resistance | ◯ | ◯ | ◯ | ◯ | ◯ | ◯ | Δ | ◯ | ◯ | ◯ | X |
| | Acid resistance | ◯ | ◯ | ◯ | ◯ | ◯ | ◯ | Δ | ◯ | ◯ | ◯ | X |
| | Scratch resistance | ◯ | ◯ | ◯ | ◯ | ◯ | ◯ | Δ | ◯ | ◯ | ◯ | X |
| | Pencil hardness | ◯ | ◯ | ◯ | ◯ | ◯ | ◯ | Δ | ◯ | ◯ | ◯ | X |
| | Bio-based content of cured | 64.0 | 59.1 | 84.5 | 32.4 | 52.0 | 27.4 | 64.9 | 58.8 | 0.0 | 0.0 | 97.3 |
| | coating film | | | | | | | | | | | |
| | Biodegradability | ◯ | ◯ | ◯ | ◯ | ◯ | ◯ | ◯ | ◯ | X | X | ◯ |

(Footnote)
Ex.: Example
Com. Ex.: Comparative Example
Syn. Ex.: Synthesis Example

In the above table, the coating film performance evaluation was carried out on the following standards.

<Appearance>:

It is examined by the eye measurement.

◯: No abnormality of the coating film surface such as swelling, cracking or pinhole is seen.

×: Abnormality of the coating film surface such as swelling, cracking or pinhole is seen.

<60° gloss>:

It is evaluated in accordance with JIS-K-5600-4-7. Specifically, it was measured using a mirror gloss meter, so that the 60° gloss of not less than 85 was evaluated as success (◯), and the 60° gloss of less than 85 was evaluated as failure (×).

<Initial Adhesion>:

It is evaluated in accordance with JIS-K-5600-5-6. Specifically, 100 checkerboard squares of 2 mm-square are formed on the coating film with a cutter knife, and onto these squares, a cellophane pressure sensitive adhesive tape is completely attached, and one opposite end of the tape is lifted and thereby released upward. This releasing operation is carried out 3 times in the same place, and the initial adhesion is shown by the number of squares in which the coating film has peeled off in an area ratio of not less than 50% within one square. The number of squares of peeling off being 0 was evaluated as success (◯), and the number of squares of peeling off being not smaller than 1 was evaluated as failure (×).

<Humidity Resistance>:

It is evaluated in accordance with JIS-K-5600-7-12. Specifically, the coating film is left for 240 hours in an atmosphere having a temperature of 50±2° C. and a humidity of 98±2%, and within 1 hour thereafter, the coating film surface is observed and subjected to a checkerboard square adhesion test. The checkerboard square adhesion test is carried out as follows. That is to say, 100 checkerboard squares of 2 mm-square are formed on the coating film with a cutter knife, and onto these squares, a cellophane pressure sensitive adhesive tape is completely attached, and one opposite end of the tape is lifted and thereby released upward. This releasing operation is carried out 3 times in the same place, and the adhesion is shown by the number of squares in which the coating film has been peeled off in an area ratio of not less than 50% within one square.

◯: No abnormality of the coating film surface such as clouding or swelling is seen, and the number of squares of peeling off is 0.

Δ: No abnormality of the coating film surface such as clouding or swelling is slightly seen, or the number of squares of peeling off is 1 to 3.

×: Abnormality of the coating film surface such as clouding or swelling is seen, and the number of squares of peeling off is not smaller than 4.

<Alkali Resistance>:

It is evaluated in accordance with JIS-K-5600-6-1. Specifically, the coating film surface is provided with a cylindrical ring, and thereinto 5 mL of a 0.1N aqueous sodium hydroxide solution is added, and the cylindrical ring is closed with a glass plate and then left at 55° C. for 4 hours. Thereafter, the coating film surface is washed with water and observed.

◯: No abnormality of the coating film surface such as clouding or swelling is seen.

Δ: Swelling is seen at 1 to 3 squares, but there is no clouding.

×: Abnormality of the coating film surface such as clouding or swelling is seen.

<Water Resistance>:

It is evaluated in accordance with JIS-K-5600-6-1. Specifically, the coating film surface is provided with a cylindrical ring, and thereinto 5 mL of distilled water is added, and the cylindrical ring is closed with a glass plate and then left at 55° C. for 4 hours. Thereafter, the coating film surface is washed with water and observed.

◯: No abnormality of the coating film surface such as clouding or swelling is seen.

Δ: Swelling is seen at 1 to 3 squares, but there is no clouding.

×: Abnormality of the coating film surface such as clouding or swelling is seen.

<Acid Resistance>:

It is evaluated in accordance with JIS-K-5600-6-1. Specifically, the coating film surface is provided with a cylindrical ring, and thereinto 5 mL of 0.1N sulfuric acid is added, and the cylindrical ring is closed with a glass plate and then left at room temperature for 24 hours. Thereafter, the coating film surface is washed with water and observed.

◯: No abnormality of the coating film surface such as contamination or swelling is seen.

Δ: Swelling is seen at 1 to 3 squares, but there is no clouding.

×: Abnormality of the coating film surface such as contamination or swelling is seen.

<Scratch Resistance>:

Steel wool #1000 to which a load of 1 kg is applied is moved back and forth 20 times on the coating film, and then the scratch degree of the coating film surface is observed by the eye measurement.

◯: Almost no scratch was seen.

Δ: A few scratches were seen.

×: Many scratches were seen.

<Hardness>:

A high-grade pencil as specified in JIS-S-6006 is used to examine how much hardness undergoes no scratch according to JIS-K-5400.

◯: Not less than H.

Δ: HB.

×: Not more than B.

<Bio-Based Content>:

It was calculated from the ratio of bio-based ingredients to all ingredients of the bio-based photopolymerizable material.

<Biodegradability>:

The obtained cured film was evaluated according to JIS-K-6953, so that a case where generation of carbon dioxide was seen was evaluated as “◯”, and a case where such generation was not seen was evaluated as “×”.

[Consideration]:

It would be understood that as to Examples 1 to 8, because of their crosslinked structures by photopolymerization, all of these Examples are excellent in the hydrolysis resistance performances such as humidity resistance, alkali resistance, water resistance and acid resistance and is also excellent in evaluation of the coating film strength such as scratch resistance and pencil hardness. In addition, it would be understood that in these Examples 1 to 8, the bio-based content is so high as to be also excellent in the biodegradability. Furthermore, it would be understood that in these Examples 1 to 8, the coating film appearance such as appearance and 60° gloss is also excellent.

Particularly, it would be understood that in Examples 1 to 6 and 8, since the branched type bio-based photopolymerizable compounds are used as film-forming ingredients, the cured films have extremely dense crosslinked structures and are therefore particularly excellent in the items relating to the hydrolysis resistance and the coating film strength.

On the other hand, in Comparative Examples 1 and 2, no bio-based ingredient is used, but conventional photopolymerizable compounds are used, so that the bio-based content is low, and also that no biodegradability is seen.

In addition, in Comparative Example 3, a photodimerizing type photoreactive compound having a cinnamic acid-based cinnamoyl group as a photoreactive group was used instead of bio-based photopolymerizable compounds, and the reaction efficiency of the photodimerization was low, so that the items relating to the hydrolysis resistance and the coating film strength were not sufficient. In addition, the 60° gloss was also inferior to Examples 1 to 8.

### INDUSTRIAL APPLICATION

The present invention can, for example, be utilized as a coating composition and its coated article which coating composition imposes only a little environmental burden while having excellent coating film performances in various fields in which coating compositions are used.

What is claimed is:

1. A photosetting type bio-based coating composition, comprising:
a bio-based photopolymerizable compound as a film-forming ingredient which compound has at least one lactic acid unit and at least one photopolymerizable group together in a molecule; and
a photopolymerization initiator.

2. The photosetting type bio-based coating composition according to claim 1, wherein the bio-based photopolymerizable compound is in the range of 1.2 to 30 in number of photopolymerizable groups per one molecule.

3. The photosetting type bio-based coating composition according to claim 1, wherein the bio-based photopolymerizable compound has a branched type structure.

4. The photosetting type bio-based coating composition according to claim 3, wherein the branched type structure is based on linkage between lactic acid units by a polyfunctional compound having a functionality of not less than 3.

5. The photosetting type bio-based coating composition according to claim 3, wherein the branched type structure is based on formation of a side chain by homopolymerization of a lactic acid macromonomer or copolymerization thereof with another monomer.

6. The photosetting type bio-based coating composition according to claim 1, wherein the photopolymerizable group is a (meth)acryloyl group and/or a styryl group.

7. The photosetting type bio-based coating composition according to claim 1, which contains a bio-based organic solvent.

8. A coated article, being obtained by being coated with the photosetting type bio-based coating composition as recited in claim 1.
